(19) United States
(12) Patent Application Publication
(10) Pub. No.: US 2007/0063870 A1
(43) Pub. Date: Mar. 22, 2007

(54) Wheel support bearing assembly having built-in wireless sensor

(75) Inventors: Koji Sahashi, Shizuoka (JP); Norihiko Sasaki, Shizuoka (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 10/573,256

(22) PCT Filed: Sep. 14, 2004
(86) PCT No.: PCT/JP04/13350

§ 371 Date: Mar. 23, 2006

(30) Foreign Application Priority Data
Sep. 24, 2003 (JP) 2003-331126

(51) Int. Cl. H04Q 9/00; G08C 19/22

(52) U.S. Cl. 340/870.07

(57) ABSTRACT

A wheel support bearing assembly includes a sensor section (6) for detecting a target of detection, and a sensor signal transmitting section (9), and an electric power receiving section (8) for receiving by wireless an electric operating power. An antenna (8a, 9a) in one or both of the sensor signal transmitting section (9) and the electric power receiving section (8) is arranged in the knuckle (11). The sensor section (6), the sensor signal transmitting section (9) and the electric power receiving section (9) may be secured, as an unitary wireless sensor unit (4), to the knuckle (11). Alternatively, the sensor signal transmitting section (9) and the electric power receiving section (8) may be secured, as a unitary transmitting and receiving unit separate from the sensor section (6), to the knuckle (11).

### FIELD OF THE INVENTION

The present invention relates to a wireless sensor incorporated wheel support bearing assembly designed to transmit a detection signal indicative of the number of revolution or the like by wireless and also to supply an electric power by wireless.

### BACKGROUND ART

A wireless ABS (Anti-lock Brake System) has been suggested, in which a signal outputted from a revolution sensor mounted on a wheel support bearing assembly, is transmitted by wireless with no harness employed between a vehicle wheel and a vehicle body structure. (See, for example, the Japanese Laid-open Patent Publication No. 2002-264786.) For the revolution sensor, a multipolar rotary electric generator is employed to provide an electric power for the sensor and an electric power for the transmission unit by means of self-generation. Accordingly, no wiring system is required for supplying an electric power to the vehicle body structure to the revolution sensor. Thus, by designing the system to be wireless, various advantages can be obtained such as, for example, reduction in weight, improvement in assemblability, avoidance of troubles resulting from breakage of harnesses brought about by collision with stones and so on.

FIG. 7 illustrates an example of the wireless sensor incorporated wheel bearing assembly of that kind. The wheel support bearing assembly shown therein includes an outer member 1 serving as a stationary member, which is secured to a knuckle 11, and a revolution sensor 56 and a sensor signal transmitting unit 54 both mounted on one end of the outer member 1. The revolution sensor 56 is made up of a pulsar ring 57 and a magnetic sensor element 58. A sensor signal receiving unit 55 is disposed within a tire housing and at a location adjacent a base end of the knuckle 1. It is to be noted that in FIG. 7, like reference numerals employed in the description of preferred embodiments of the present invention are equally employed to denote like parts.

Also, the wheel support bearing assembly, in which an electric power is supplied to the revolution sensor by wireless, has also been suggested. (See, for example, the Japanese Laid-open Patent Publication No. 2003-146195.) With this wireless supply of the electric power, unlike the utilization of an electric power self-generation, detection of the revolution and transmission of the sensor signal can be carried out even during the suspension of revolution and the low speed revolution.

Within the tire housing, little ample space is available so much in the vicinity of the wheel support bearing assembly. In particular, as shown in FIG. 7, since on the driving side an outer race 15a of the constant velocity joint 15 for transmission of the torque is coupled with the inner member 2 of the wheel support bearing assembly, the space available is considerably limited. For this reason, where the sensor signal transmitting unit 54 is provided in the outer member 1 as shown, the sensor signal receiving unit 55 and the sensor signal transmitting unit 54 cannot be positioned directly in face-to-face relation with each other and the outer race 15a of the constant velocity joint tends to constitute an interfering obstacle. Transmission and reception of the signals by the use of electromagnetic waves would pose no problem even though the interfering obstacle is present therebetween. Nevertheless, the presence of the interfering obstacle results in reduction in efficiency particularly where in order to avoid radio interference and compactize component parts, the frequency and the directivity are increased.

In the case of the wireless electric power supply, a highly efficient supply of the electric power is required since a relatively large electric power must be captured as compared with the transmission and reception of the sensor signal. Accordingly, it is contemplated to render the transmission frequency be increased to a high frequency in the range of GHz to enable even a compact antenna to accomplish an efficient reception. In such case, the presence of the interfering obstacle between the sensor signal receiving unit and the sensor signal transmitting unit as discussed above results in reduction of the efficiency of electric power supply. This reduction in efficiency of the electric power supply does in turn lead to reduction in mileage.

### DISCLOSURE OF THE INVENTION

An object of the present invention is to provide a wireless sensor incorporated wheel support bearing assembly, in which the freedom or flexibility of space for positioning communication component parts can be increased so that the highly efficient wireless supply of the electric power or highly efficient transmission and reception of the sensor signal can be achieved.

The wireless sensor incorporated wheel support bearing assembly according to the present invention is directed to a wheel support bearing assembly for rotatably supporting a vehicle wheel relative to a vehicle body structure, which includes an outer member (1) having an inner periphery formed with a plurality of raceways (1a, 1b) and adapted to be secured to the vehicle body structure through a knuckle (11); an inner member (2) having raceways (2a, 2b) confronting with the raceways (1a, 1b) in the outer member (1); and a plurality of rolling elements (3) interposed between the raceways (1a, 1b) in the outer member and the raceways (2a, 2b) in the inner member that confront with each other; in which there is provided a sensor section (6) for detecting a target of detection, a sensor signal transmitting section (9) for transmitting by wireless a sensor signal outputted from the sensor section (6), and an electric power receiving section (8) for receiving by wireless an electric operating power for the sensor section (6) and the sensor signal transmitting section (9) and in which the knuckle (11) is provided with at least an antenna (8a, 9a) in one or both of the sensor signal transmitting section (9) and the electric power receiving section (8).

According to the construction described above, the sensor signal detected by the sensor section (6) can be transmitted by the sensor signal transmitting section (9), and the sensor section (6) and the sensor signal transmitting section (9) can be driven by the electric operating power received by the electric power receiving section (8). Accordingly, it is possible to eliminate the necessity of use of any harness between the vehicle wheel and the vehicle body structure in order to achieve reduction in weight, improvement in assemblability, avoidance of troubles resulting from breakage of harnesses brought about by collision with stones and so on. Because of the wireless electric power transmission, unlike the case in which the electric power is self-generated, detection of the revolution with the sensor section (6) can be carried out even during the suspension of revolution and the low speed revolution. In such case, since at least antennas (8a, 9a) of both or one of the sensor signal transmitting section (9) and the electric power receiving section (8) are arranged in the knuckle (11), the spacial flexibility of positioning of the sensor signal transmitting section (9) and the electric power receiving section (8) can be increased due to the efficient utilization of the space around the wheel support bearing assembly. For this reason, the respective antennas (8a, 9a) of the sensor signal transmitting section (9) and the electric power receiving section (8) can be arranged at a proper position, where no interfering obstacle exist, relative to positions of the sensor signal receiving device and the electric power transmitting device both mounted on the vehicle body structure. Therefore, even when the high frequency band such as having the directivity is used for the transmission of the electric power or the sensor signal, it is possible to avoid reduction in efficiency which would result from the presence of the interfering obstacle.

If at least the antennas (8a, 9a) are arranged in the knuckle (11), the sensor signal transmitting section (9) and the electric power receiving section (8) can be easily located at a position effective to avoid intervention of the interfering obstacle in the wireless communication path where the electromagnetic waves travel. However, not only the antennas (8a, 9a), but one or both of the sensor signal transmitting section (9) and the electric power receiving section (8) may be, in its substantial entirety, arranged in the knuckle (11). Increase of portion of those sections arranged in the knuckle (11) can render it easy to utilize the space around the wheel support bearing assembly.

The sensor signal transmitting section (9) and the electric power receiving section (8) may be integrated together into a unitary component to define a transmitting and receiving unit (7), and the transmitting and receiving unit (7) may then be secured to the knuckle (11). Securement of the transmitting section and the receiving section as one unit (7) to the knuckle (11) is effective to compactize a transmitting and receiving means.

The sensor section (6), together with the sensor signal transmitting section (9) and the electric power receiving section (8) may be integrated into a unitary component to define a wireless sensor unit (4) and this wireless sensor unit (4) may then be secured to the knuckle. By so doing, further compactization is possible. Also, mere securement of the knuckle (11) to the outer member (1) can facilitate positioning of the sensor section (6) relative to a target of detection to be detected thereby.

In the present invention, the sensor section (6) may include a revolution sensor including a pulsar ring (17) and a magnetic sensor (18). In such case, the magnetic sensor (18) of the revolution sensor, the sensor signal transmitting section (9) and the electric power receiving section (8) may be integrated together into a unitary component to define a wireless sensor unit (4). This wireless sensor unit (4) may be secured to the knuckle (11) while the pulsar ring (17) may be mounted on the inner member (2).

In the case of this construction described above, not only does the integration facilitate compactization, but also securement of the unit to the knuckle (11) results in increase of the spacial flexibility for installation. Also, securement of the knuckle (11) to the outer member (1) facilitates positioning of the magnetic sensor (18) relative to the pulsar ring (17).

In such case, when an outer race of a constant velocity joint is fitted to the inner member or is provided as a component part of the inner member, the pulsar ring may be mounted on the outer race of the constant velocity joint. In the case of this construction, the further spacial flexibility for installation can be increased as the pulsar ring is mounted on the outer race of the constant velocity joint where a relatively large free space is available.

The wireless sensor incorporated wheel support bearing assembly of the present invention is provided with the sensor section for detecting the target of detection, the sensor signal transmitting section for transmitting by wireless a sensor signal outputted from the sensor section, and the electric power receiving section for receiving by wireless from the electric power transmitting device, an electric operating power for the sensor section and the sensor signal transmitting section, and at least the antenna is provided in one or both of the sensor signal transmitting section and the electric power receiving section. Therefore, the spacial flexibility for installation of component parts for wireless communication can be increased to enable the efficient wireless electric power supply or the efficient sensor signal transmission and receipt to be accomplished.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view of a wireless sensor incorporated wheel support bearing assembly according to a first preferred embodiment of the present invention;

FIG. 2 is a circuit block diagram of a wireless sensor unit and a sensor signal receiving unit both employed in the wireless sensor incorporated wheel support bearing assembly according to the first preferred embodiment;

FIG. 3A is a fragmentary front elevational view of a sensor section;

FIG. 3B is an enlarged sectional view of the sensor section employed in the first preferred embodiment;

FIG. 4 is a longitudinal sectional view of the wireless sensor incorporated wheel support bearing assembly according to a second preferred embodiment of the present invention;

FIG. 5 is a longitudinal sectional view of the wireless sensor incorporated wheel support bearing assembly according to a third preferred embodiment of the present invention;

FIG. 6 is a longitudinal sectional view of the wireless sensor incorporated wheel support bearing assembly according to a fourth preferred embodiment of the present invention; and

FIG. 7 is a longitudinal sectional view showing the conventional wireless sensor incorporated wheel support bearing assembly.

### BEST MODE FOR CARRYING OUT THE INVENTION

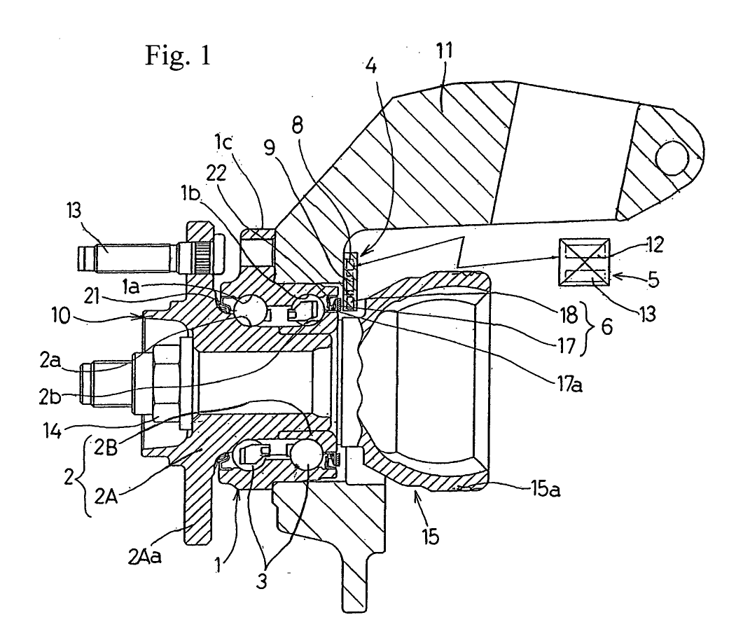

The first preferred embodiment of the present invention will be described in detail with particular reference to FIGS. 1 to 3. A wireless sensor incorporated wheel support bearing assembly 10 shown therein includes an outer member 1 having an inner periphery formed with a plurality of raceways 1a and 1b, an inner member 2 having raceways 2a and 2b respectively confronting with the raceways 1a and 1b referred to above, and a plurality of rows of rolling elements 3 interposed between the raceways 1a and 1b and the raceways 2a and 2b that confront with each other and is used for rotatably supporting a vehicle wheel relative to the vehicle body structure. An annular bearing space delimited between the outer member 1 and the inner member 2 has its opposite open ends sealed by respective sealing members 21 and 22. The outer member 1 has an outer periphery formed with a flange 1c and is secured to the vehicle body structure through a knuckle 11. The knuckle 11 is mounted on an inboard end of the outer periphery of the outer member 1, a mounting portion of which is secured to the flange 1c through a plurality of bolts not shown. This wheel support bearing assembly 10 is of a third generation type including a flange formed in both of the inner member and the outer member, in which the inner member 2 is made up a hub axle 2A and an inner race segment 2B, with the raceways 2a and 2b defined in the hub axle 2A and the inner race segment 2B, respectively. The hub axle 2A has an outer periphery formed with a flange 2Aa to which the vehicle wheel (not shown) is rigidly secured by means of a plurality of bolts 13. A constant velocity joint 15 includes an outer race 15a having a shaft portion inserted into the hub axle 2A and then coupled thereto through a nut 14.

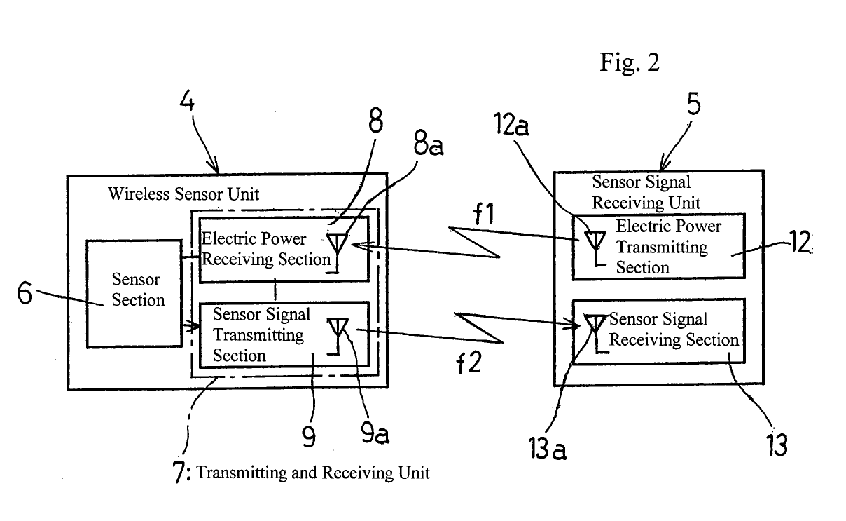

In this wheel support bearing assembly 10, a wireless sensor unit 4 is secured to the knuckle 11. This wireless sensor unit 4 includes, as shown in FIG. 2, a sensor section 6 for detecting a target of detection, a sensor signal transmitting section 9 for transmitting by wireless a sensor signal outputted form the sensor section 6, and an electric power receiving section 8 for receiving by wireless an electric operating power required to drive the sensor section 6 and the sensor signal transmitting section 9. A capacitor or a secondary battery (both not shown) for accumulating the electric power received by the electric power receiving section 8 may be employed. The sensor signal transmitting section 9 includes a transmitting antenna 9a and a transmitting circuit (not shown). The electric power receiving section 8 includes a receiving antenna 8a and a receiving circuit. The sensor signal transmitting section 9 and the electric power receiving section 8 may be integrated together into a unitary component to provide a transmitting and receiving unit 7.

The wireless sensor unit 4 and the sensor signal receiving unit 5 altogether constitute the wireless sensor system. The sensor signal receiving unit 5 includes a sensor signal receiving section 13 for receiving a sensor signal transmitted from the sensor signal transmitting section 9 of the wireless sensor unit 4, and an electric power transmitting section 12 for transmitting by wireless an electric operating power to the electric power receiving section 8. The sensor signal receiving section 13 includes an antenna 13a and a receiving circuit and, on the other hand, the electric power transmitting section 12 includes an antenna 12a and a transmitting circuit. Transmission and reception between the sensor signal transmitting section 9 and the sensor signal receiving section 13 and between the electric power transmitting section 12 and the electric power receiving section 8 may be carried out by the utilization of electromagnetic waves, light waves, infrared beams or ultrasonic waves or through a magnetic coupling.

Where communication is made by the utilization of the electromagnetic waves, the sensor signal and the electric power, both transmitted by wireless, have respective frequencies different from each other. In the illustrated embodiment, the frequency of the electric power is denoted by f1 and the frequency of the sensor signal is denoted by f2. The frequency f1 of the electric power is preferably high, for example, within the GHz range, in order to compactize the antennas and also to increase the electric power supply efficiency by increasing the directivity.

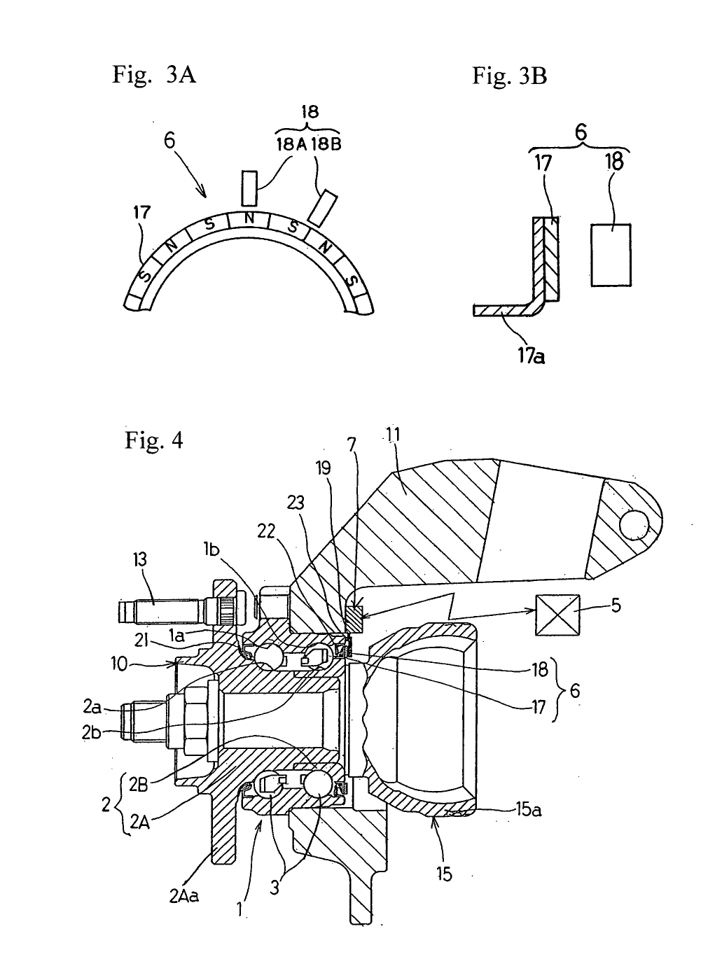

As best shown in FIG. 3, the sensor section 6 includes a pulsar ring 17 and a magnetic sensor 18 disposed in face-to-face relation with the pulsar ring 17. The pulsar ring 17 is of a type having a cyclic change in the circumferential direction thereof such as, in the form of a magnet having a plurality of alternating magnetic poles N and S deployed in a direction circumferentially thereof, or a magnetic ring having gear-like serrations defined therein. A combination of the pulsar ring 17 in the form of the multipolar magnet and the magnetic sensor 18 is effective to provide a compact and precise revolution sensor. The magnet forming the pulsar ring 17 may be a rubber magnet, a plastics magnet or a sintered magnet. For the magnetic sensor 18, one magnetic sensor may be employed or, alternatively, the magnetic sensor 18 may have two detecting elements 18A and 18B spaced from each other about 90° in phase relative to the cycle of magnetic change in the circumferential direction of the pulsar ring 17. Where the magnetic sensor 18 have those two detecting elements 18A and 18B, respective revolution signals spaced about 90° in phase from each other can be outputted from the detecting elements 18A and 18B and, therefore, the direction of revolution can be detected.

The magnetic sensor 18 may be employed in the form of a magnetoresistance sensor (generally referred to as “MR sensor”), or an active magnetic field sensor such as, for example, a Hall element sensor, a flux gate type magnetic field sensor, MI sensor. Of those sensors, the magnetoresistance sensor is particularly suitable for the wireless supply of the electric power since the electric power consumption can be minimized when the resistance is increased.

The pulsar ring 17 forming a part of the sensor section 6 is mounted externally on the outer periphery of the inner member 2, as shown in FIG. 1, through a metal core 17a. The magnetic sensor 18 forming another part of the sensor section 6 is integrated into a unitary component together with the sensor signal transmitting section 9 and the electric power receiving section 8. By way of example, the magnetic sensor 18, the sensor signal transmitting section 9 and the electric power receiving section 8 are all accommodated within a common casing. The wireless sensor unit 4, which is an integrated unitary component, is secured to the knuckle 11.

It is to be noted that the sensor section 6 may also include, in addition to the magnetic sensor 18, a sensor capable of detecting a target of detection other than the revolution (not shown) such as, foe example, temperature, vibration acceleration, preload on the bearing assembly, load and/or torque. In such case, the various sensor signals can be transmitted from the same sensor signal transmitting section 9 in the form as superimposed or on a time sharing basis.

The sensor signal receiving unit 5 is arranged within the tire housing, forming a part of the vehicle body structure, at a location near to, for example, the base end of the knuckle 11. In such case, with respect to the respective antennas 9a and 8a (shown in FIG. 2) of the sensor signal transmitting section 9 and the electric power receiving section 8, both forming respective parts of the wireless sensor unit 4, the sensor signal receiving unit 5 is disposed where no interfering obstacle such as, for example, the constant velocity joint 15 exist on the straight path between the corresponding antennas.

According to the wireless sensor incorporated wheel support bearing assembly of the structure described above, the sensor signal such as the revolution signal detected by the sensor section 6 is transmitted by the sensor signal transmitting section 9 and, on the other hand, the electric operating power is received by the electric power receiving section 8 to drive the sensor section 6 and the sensor signal transmitting section 9. Accordingly, it is possible to eliminate the necessity of use of any harness between the vehicle wheel and the vehicle body structure in order to achieve reduction in weight, improvement in assemblability and avoidance of troubles resulting from breakage of harnesses brought about by collision with stones and so on. Because of the wireless electric power transmission, unlike the case in which the electric power is self-generated, detection of the revolution with the sensor section 6 can be carried out even during the suspension of revolution and the low speed revolution.

In such case, since the sensor signal transmitting section 9 and the electric power receiving section 8 are arranged in the knuckle 11, the space around the wheel support bearing assembly 10 can be effectively utilized to increase the flexibility of locating of the sensor signal transmitting section 9 and the electric power receiving section 8. Accordingly, relative to the sensor signal receiving section 13 and the electric power transmitting section 12, both secured to the vehicle body structure, the respective antenna 9a and 8a of the sensor signal transmitting section 9 and the electric power receiving section 8 can be arranged at a proper position where no interfering obstacle exist therebetween. In view of this, even when the high frequency band such as GHz range having the high directivity is used for the transmission and receipt of the electric power and the sensor signals, it is possible to avoid reduction in efficiency which would result from the presence of the interfering obstacle.

Also, since in the foregoing embodiment, the magnetic sensor 18 of the sensor section 6, the sensor signal transmitting section 9 and the electric power receiving section 8 are integrated into the unitary component that is in turn secured to the knuckle, they are compactized in entirety. Therefore, the spacial flexibility for installation is increased and a high installability can be obtained. Also, mere securement of the outer member 1 to the knuckle 11 can result in positioning of the pulsar ring 17, that forms a to-be-detected element, relative to the magnetic sensor 18 of the sensor section 6.

FIG. 4 illustrates a second preferred embodiment of the present invention. This second embodiment is such that the sensor signal transmitting section 9 and the electric power receiving section 8, both shown in FIG. 2, are accommodated within a common casing and are thus integrated together into a unitary structure to thereby provide a transmitting and receiving unit 7, and this transmitting and receiving unit 17 is coupled with the magnetic sensor 18 of the sensor section 6 through a wiring system 19 or a connector. This transmitting and receiving unit 7 is secured to the knuckle 11, but the magnetic sensor 18 is fitted to the outer member 1 through a fitting member 23. Other structural features are substantially similar to those shown and described in connection with the foregoing first embodiment with reference to FIGS. 1 to 3.

In the case of this construction, since the transmitting and receiving unit 17 is secured to the knuckle 11, an increased spacial flexibility for installation can be obtained. Also, since the sensor signal transmitting section 9 and the electric power receiving section 8 are integrated into the unitary structure, that is, the transmitting and receiving unit 7, it is possible to achieve compactization.

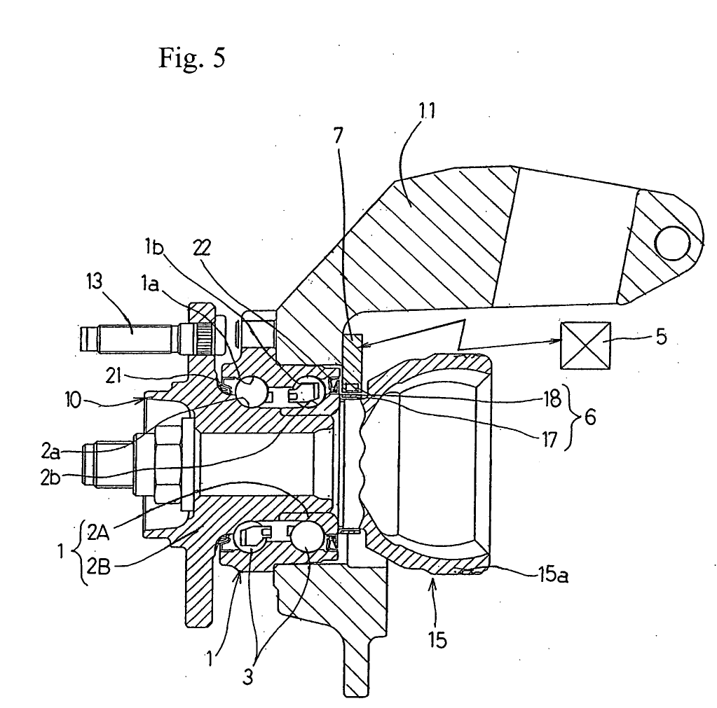

FIG. 5 illustrates a third preferred embodiment of the present invention. This third embodiment is substantially similar to the foregoing first embodiment shown in and described with reference to FIGS. 1 to 3, except that the sensor section 6 in this third embodiment is employed in the form of a revolution sensor of a radial type and the pulsar ring 17 thereof is mounted on the outer race 15a of the constant velocity joint 15.

In the case of this construction, since the pulsar ring 17 is fitted to the outer race 15a of the constant velocity joint, around which a relatively large free space is available, the spacial flexibility for installation can be increased further. Other structural features are substantially similar to those shown and described in connection with the foregoing first embodiment.

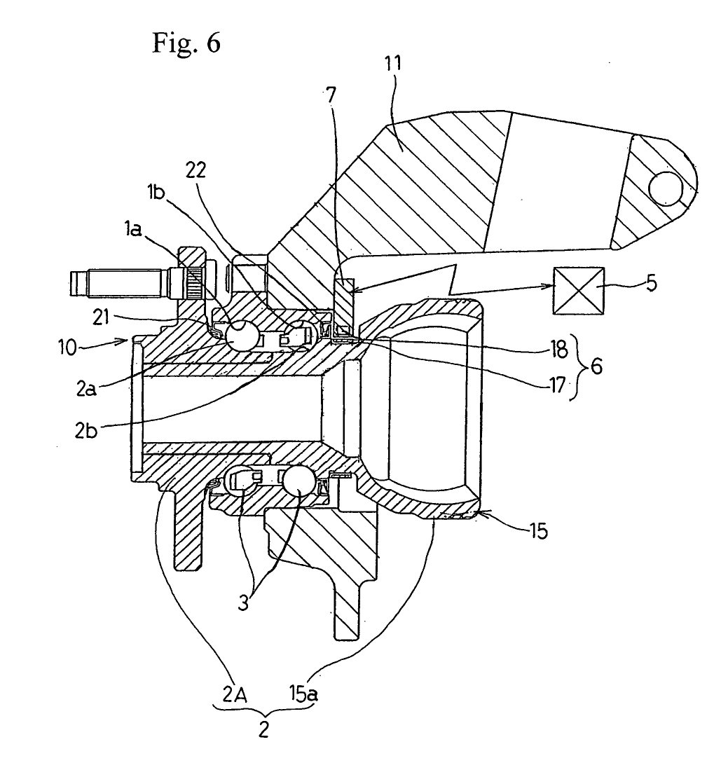

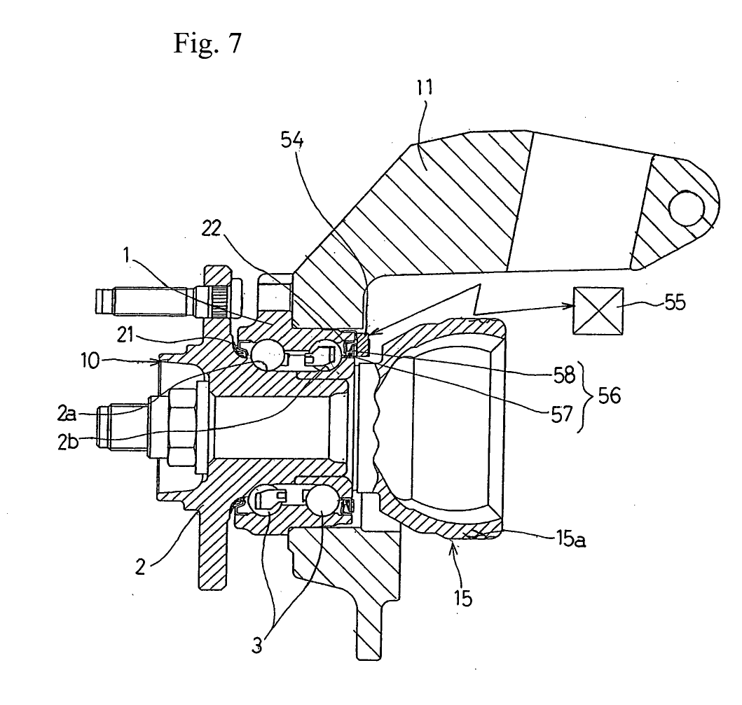

FIG. 6 illustrates a fourth preferred embodiment of the present invention. This fourth embodiment is such that the wheel support bearing assembly 10 is rendered to be of a fourth generation type. In this embodiment, the inner member 2 is made up of a hub axle 2A and an outer race 15a of the constant velocity joint 15, with the raceways 2a and 2b of the inner member 2 defined in the hub axle 2A and the outer race 15a of the constant velocity joint 15, respectively. The sensor section 6 is employed in the form of the revolution sensor of a radial type as is the case with that in the third embodiment shown in and described with reference to FIG. 5 and the pulsar ring 17 thereof is mounted on the outer race 15a of the constant velocity joint 15.

In describing each of the foregoing embodiments, the sensor section 6, the sensor signal transmitting section 9 and the electric power receiving section 8 have been shown and described as integrated together into the unitary structure to provide the wireless sensor unit 4, or the sensor signal transmitting section 9 and the electric power receiving section 8 are shown and described as integrated together into the unitary structure to provide the transmitting and receiving unit 7. However, such unitary structure is not always necessary and the sensor section 6, the sensor signal transmitting section 9 and the electric power receiving unit 8 may be mounted separately. In such case, either one of the sensor signal transmitting section 9 and the electric power receiving section 8 suffices to be secured to the knuckle 11. Also, both of the sensor signal transmitting section 9 and the electric power receiving section 8 may not be necessarily secured to the knuckle 11 and at least the antennas 9a and 8a suffice to be arranged on the knuckle 11. Even in such case, it is possible to avoid the intervention of an interfering obstacle such as the outer race 15a of the constant velocity joint 15 on the path of transmission of the electromagnetic waves between them and the sensor signal receiving unit 5, resulting in increase of the spacial flexibility for installation of the various component parts.

What is claimed is:

1. A wireless sensor incorporated wheel support bearing assembly for rotatably supporting a vehicle wheel relative to a vehicle body structure, which assembly comprises
an outer member having an inner periphery formed with a plurality of raceways and adapted to be secured to the vehicle body structure through a knuckle;
an inner member having raceways confronting with the raceways in the outer member;
a plurality of rolling elements interposed between the raceways in the outer member and the raceways in the inner member that confront with each other;
a sensor section for detecting a target of detection;
a sensor signal transmitting section for transmitting by wireless a sensor signal outputted from the sensor section; and
an electric power receiving section for receiving by wireless an electric operating power for the sensor section and the sensor signal transmitting section,
wherein the knuckle is provided with at least an antenna in one or both of the sensor signal transmitting section and the electric power receiving section.

2. The wireless sensor incorporated wheel support bearing assembly as claimed in claim 1, wherein one or both of the sensor signal transmitting section and the electric power receiving section are, in its substantial entirety, arranged in the knuckle.

3. The wireless sensor incorporated wheel support bearing assembly as claimed in claim 1, wherein the sensor signal transmitting section and the electric power receiving section are integrated together into a unitary component to define a transmitting and receiving unit, the transmitting and receiving unit being secured to the knuckle.

4. The wireless sensor incorporated wheel support bearing assembly as claimed in claim 1, wherein the sensor signal transmitting section, the electric power receiving section and the sensor section are integrated together into a unitary component to define a wireless sensor unit, the wireless sensor unit being secured to the knuckle.

5. The wireless sensor incorporated wheel support bearing assembly as claimed in claim 1, wherein the sensor section comprises a revolution sensor including a pulsar ring and a magnetic sensor and wherein the pulsar ring is mounted on the inner member and the magnetic sensor of the revolution sensor unit, the sensor signal transmitting section and the electric power receiving section are integrated together into a unitary component to define a wireless sensor, the wireless sensor unit being secured to the knuckle.

6. The wireless sensor incorporated wheel support bearing assembly as claimed in claim 5, further comprising an outer race of a constant velocity joint fitted to the inner member or provided as a component part of the inner member, wherein the pulsar ring is mounted on the outer race of the constant velocity joint.
